(19) United States
(12) Patent Application Publication
(10) Pub. No.: US 2024/0183181 A1
(43) Pub. Date: Jun. 6, 2024

(54) SWIMMING POOL TEMPERATURE ADJUSTMENT EQUIPMENT

(71) Applicant: Guangdong TCL Intelligent Heating & Ventilating Equipment Co., LTD., Zhongshan, Guangdong (CN)

(72) Inventors: Yonghai Gao, Zhongshan, Guangdong (CN); Hongfeng Chen, Zhongshan, Guangdong (CN); Rui Yang, Zhongshan, Guangdong (CN); Wenjie Dai, Zhongshan, Guangdong (CN)

(73) Assignee: Guangdong TCL Intelligent Heating & Ventilating Equipment Co., LTD., Zhongshan, Guangdong (CN)

(21) Appl. No.: 17/904,092

(22) PCT Filed: Dec. 31, 2021
(86) PCT No.: PCT/CN2021/144031

§ 371 Date: Aug. 11, 2022

(30) Foreign Application Priority Data
Dec. 21, 2021 (CN) 202111572967.3

(51) Int. Cl. E04H 4/12; E04H 4/16; F24H 1/54

(52) U.S. Cl. CPC E04H 4/129; E04H 4/1245; E04H 4/16; F24H 1/54

(57) ABSTRACT

A swimming pool temperature adjustment equipment includes a container having a water inlet port and a water outlet port; a water circuit system and a dehumidifying and temperature adjustment device both arranged in the container, the water circuit system having a water inlet end connected to the water inlet port and a water outlet end connected to the water outlet port; the dehumidifying and temperature adjustment device used to dehumidify air and adjust temperature of water flow in the water circuit system; and a disinfection device connected to the water circuit system and used to disinfect the water flow in the water circuit system. The swimming pool temperature adjustment equipment has complete functions, which is convenient for handling and installation.

### BACKGROUND OF DISCLOSURE

### Technical Field

The present application relates to a technical field of swimming pool water treatment equipment, and in particular to a swimming pool temperature adjustment equipment.

### Description of the Prior Art

As a leisure sport, swimming is loved by more and more people, therefore in order to swim at any time, family swimming pools have gradually become a necessary living facility for people. People pay special attention to life science, sports, and entertainment, and therefore, demands for constant temperature of swimming pool water during all seasons and constant humidity of surrounding environment of the swimming pool are constantly increasing. At a same time, there are also certain requirements for maintenance of water quality of the swimming pools.

At present, air source heat pumps are generally used in the swimming pools to heat the pool water, which has a single function. When air needs to be dehumidified, an indoor dehumidifier needs to be added to dehumidify moisture in the air. When the swimming pool water needs to be sterilized and disinfected, it is necessary to add chlorine water to disinfect the pool water. In this scheme, equipment components used in treatment of the swimming pools are independent products with single functions. When needed, they need to be separately purchased from markets and be installed separately according to requirements.

### BRIEF SUMMARY OF DISCLOSURE

### Technical Problem

A main purpose of the present application is to provide a swimming pool temperature adjustment equipment to solve a problem of single function of existing swimming pool temperature adjustment equipment.

The present application provides a swimming pool temperature adjustment equipment, which comprises:
a container having a water inlet port and a water outlet port;
a water circuit system arranged in the container and having a water inlet end and a water outlet end; the water inlet end connected to the water inlet port, and the water outlet end connected to the water outlet port;
a dehumidifying and temperature adjustment device arranged in the container, water flow in the water circuit system flowing through the dehumidifying and temperature adjustment device, the dehumidifying and temperature adjustment device used to adjust temperature of the water flow in the water circuit system, and the dehumidifying and temperature adjustment device also used to dehumidify air; and
a disinfection device connected to the water circuit system, and the disinfection device used to disinfect the water flow in the water circuit system.

The swimming pool temperature adjustment equipment proposed in the present application can dehumidify the air by setting the dehumidifying and temperature adjustment device, so that it can reduce humidity of surrounding environment, and improve comfort of the surrounding environment. And the water circuit system flows through the dehumidifying and temperature adjustment device, that is, the water flow in the swimming pool flows enters the water circuit system through the water inlet end of the water circuit system, and then flows through the dehumidifying and temperature adjustment device, and the dehumidifying and temperature adjustment device can exchange heat with the water flow in the water circuit system to realize adjusting temperature of the water flow. The temperature adjusted water flow can flow into the swimming pool through the water outlet end of the water circuit system, so as to realize adjusting temperature of the swimming pool water. And a disinfection device connected to the water circuit system is provided, the water flow in the water circuit system can be disinfected by the disinfection device. The water circuit system, dehumidifying and temperature adjustment device, and disinfection device are integrated at the container, that is, the swimming pool temperature adjustment equipment has functions of dehumidifying the air, adjusting the temperature of the swimming pool water, and disinfecting the swimming pool water at a same time. One device can meet various functional requirements, and the integration of the water circuit system, dehumidifying and temperature adjustment device, and disinfection device at the container can also improve convenience of swimming pool temperature adjustment equipment. When it needs to be used, it only needs to take the whole machine, which is convenient for handling and installation.

### BRIEF DESCRIPTION OF DRAWINGS

FIG. 1 is a schematic structural diagram of a swimming pool temperature adjustment equipment provided in the present application.

FIG. 2 is a schematic structural diagram of the swimming pool temperature adjustment equipment shown in FIG. 1 from another perspective.

FIG. 3 is a first schematic structural diagram of the swimming pool temperature adjustment equipment shown in FIG. 1 when a cover is not installed.

FIG. 4 is a schematic structural diagram of the swimming pool temperature adjustment equipment shown in FIG. 3 from another perspective.

FIG. 5 is a first schematic diagram of the swimming pool temperature adjustment equipment provided in the present application.

FIG. 6 is a second schematic diagram of the swimming pool temperature adjustment equipment provided in the present application.

FIG. 7 is a second schematic structural diagram of the swimming pool temperature adjustment equipment shown in FIG. 1 when the cover is not installed.

### DETAILED DESCRIPTION OF PREFERRED EMBODIMENTS

The technical solutions in embodiments of the present application will be clearly and completely described below with reference to accompanying drawings in the embodiments of the present application. Obviously, the described embodiments are only a part of the embodiments of the present application, but not all of the embodiments. Based on the embodiments in the present application, all other embodiments obtained by those skilled in the art without creative efforts shall fall within a protective scope of the present application.

A swimming pool temperature adjustment equipment is provided in the embodiments of the present application to solve a problem of single function of existing swimming pool temperature adjustment equipment. This will be described below with reference to the accompanying drawings.

The swimming pool temperature adjustment equipment provided in the embodiments of the present application can be applied to swimming pools, and is used to deal with swimming pool water and dehumidify surrounding environment to make the swimming pool more suitable for swimmers to swim.

It should be noted that with increasing entertainment requirements, people have certain requirements for temperature and quality of the swimming pool water and humidity of the surrounding environment of the swimming pool. For example, in swimming pools, air source heat pumps are generally used to heat the pool water, and an indoor dehumidifying device is added to dehumidify moisture in air. When the swimming pool water needs to be disinfected, it is necessary to add chlorine water to disinfect the pool water. The equipment components for handling of the swimming pool water in this scheme are independent products. When they are needed, they need to be purchased separately from markets according to requirements, and then delivered to a site for assembly and integration, which not only increases procurement workload and cargo transportation cycle, but also installation workload and maintenance difficulty, which is not convenient to install and use.

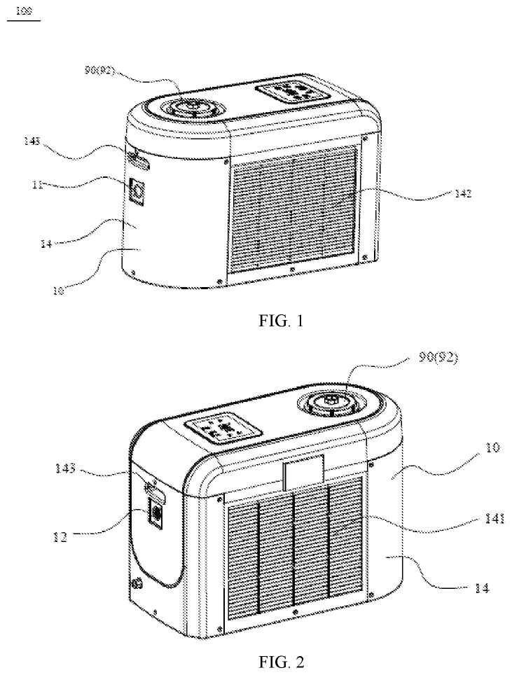

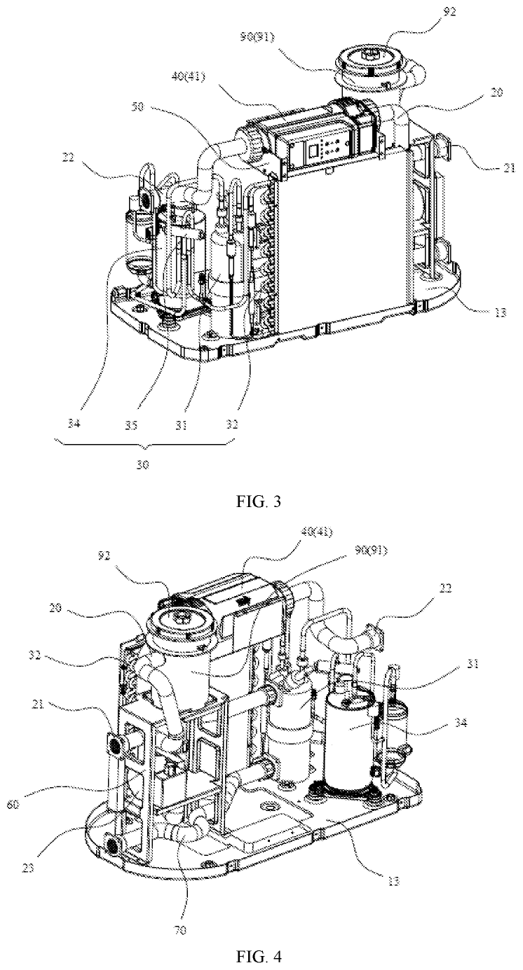

Based on this, please refer to FIGS. 1-3, FIG. 1 is a schematic structural diagram of a swimming pool temperature adjustment equipment provided in the present application. FIG. 2 is a schematic structural diagram of the swimming pool temperature adjustment equipment shown in FIG. 1 from another perspective. FIG. 3 is a first schematic structural view of the swimming pool temperature adjustment equipment shown in FIG. 1 when a cover is not installed. The embodiment of the present application provides a swimming pool temperature adjustment equipment 100 including a container 10, a water circuit system 20, a dehumidifying and temperature adjustment device 30, and a disinfection device 40. The container 10 has a water inlet port 11 and a water outlet port 12. The water circuit system 20 is arranged in the container 10 and has a water inlet end 21 and a water outlet end 22. The water inlet end 21 of the water circuit system 20 is connected to the water inlet port 11, and the water outlet end 22 of the water circuit system 20 is connected to the water outlet port 12. Water in the swimming pool can be introduced from the water inlet end 21 of the water circuit system 20 and flow back into the swimming pool from the water outlet end 22 of the water circuit system 20 after circulating in the water circuit system 20. For example, water pipes can be connected externally at the water inlet port 11 and the water outlet port 12 of the container 10. Specifically, the water pipes comprise a water inlet pipe and a water outlet pipe. One end of the water inlet pipe extends into the swimming pool, and another end of the water inlet pipe is connected to the water inlet end 21 of the water circuit system 20 by a first quick connecting port. One end of the water outlet pipe is connected to the water outlet end 22 of the water circuit system 20 by a second quick connecting port, and another end of the water outlet pipe extends into the swimming pool. The water circuit system 20 can pump the water in the swimming pool into the water circuit system 20 from the water inlet pipe and circulate back into the swimming pool from the water outlet pipe, so that the water in the swimming pool can circulate among the swimming pool, the water circuit system 20, and the swimming pool.

The dehumidifying and temperature adjustment device 30 is arranged in the container 10. The water flow in the water circuit system 20 flows through the dehumidifying and temperature adjustment device 30. The dehumidifying and temperature adjustment device 30 can be used to dehumidify the air, thereby reducing humidity of the surrounding environment, and improving comfort of the surrounding environment. When the water flow in the water circuit system 20 flows through the dehumidifying and temperature adjustment device 30, the dehumidifying and temperature adjustment device 30 can be used to adjust temperature of the water flow in the water circuit system 20, so that the water temperature in the swimming pool can be more suitable for human needs.

The disinfection device 40 is connected to the water circuit system 20, and the disinfection device 40 is used to disinfect the water flow in the water circuit system 20, so as to improve water quality of the swimming pool. It can be understood that the swimming pool temperature adjustment equipment 100 provided in the embodiment of the present application has various functions to meet various requirements of people. The dehumidifying and temperature adjustment device 30 can be used to dehumidify the air, thereby reducing humidity of the surrounding environment, and improving comfort of the surrounding environment. The water flow in the water circuit system 20 flows through the dehumidifying and temperature adjustment device 30, that is, the water in the swimming pool can flow from the water inlet end 21 of the water circuit system 20 to the water circuit system 20, and then flow through the dehumidifying and temperature adjustment device 30; and the dehumidifying and temperature adjustment device 30 can exchange heat with the water flow in the water circuit system 20 to realize temperature adjustment of the water flow. The temperature-adjusted water flow can flow from the water outlet end 22 of the water circuit system 20 to the swimming pool, so that the temperature adjustment of the water in the swimming pool is realized. By providing the disinfection device 40 connected to the water circuit system 20, the disinfection device 40 can disinfect the water flow in the water circuit system 20, so that water quality can be improved. The water circuit system 20, the dehumidifying and temperature adjustment device 30, and disinfection device 40 are integrated at the container 10, that is, the swimming pool temperature adjustment equipment 100 has functions of dehumidifying the air, adjusting the temperature of the swimming pool water, and disinfecting the swimming pool water at a same time. One device can meet various functional requirements, and the integration of the water circuit system 20, the dehumidifying and temperature adjustment device 30, and the disinfection device 40 at the container 10 can also improve convenience of use of swimming pool temperature adjustment equipment 100. When you need to use it, you only need to take a whole machine, which is convenient for carrying and installation.

It can be understood that the disinfection device 40 can be installed outside the container 10 or inside the container 10. When the disinfection device 40 is installed outside the container 10, it can facilitate operation of the disinfection device 40, such as maintenance or adding disinfectant. When the disinfection device 40 is installed in the container 10, it can be protected by the container 10 and is not easily damaged.

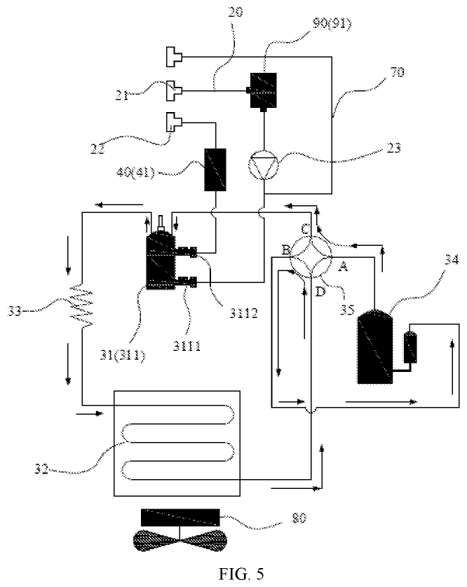

In some embodiments, please refer to FIG. 4 in conjunction with FIG. 1 to FIG. 3. FIG. 4 is a schematic structural diagram of the swimming pool temperature adjustment equipment shown in FIG. 3 from another perspective. The container 10 includes a base portion 13 and a cover 14. The water circuit system 20, the dehumidifying and temperature adjustment device 30, and the disinfection device 40 can be supported on the base portion 13. The cover 14 is arranged on the base portion 13 and accommodates the water circuit system 20, the dehumidifying and temperature adjustment device 30, and the disinfection device 40. The cover 14 is provided with the water inlet port 11 and the water outlet port 12. Of course, the dehumidifying and temperature adjustment device 30 can also be directly supported on the base portion 13. The disinfection device 40 is installed on a wall of the cover 14 by a first mounting bracket 50. The water circuit system 20 is supported on the base portion 13 by a second mounting bracket 60.

As shown in FIG. 1 and FIG. 2, in order to facilitate transportation of the swimming pool temperature adjustment equipment 100, a handle 143 may be provided on the container 10, for example, the handle 143 may be provided on a wall of the cover 14, so as to facilitate the transportation of the swimming pool temperature adjustment equipment 100.

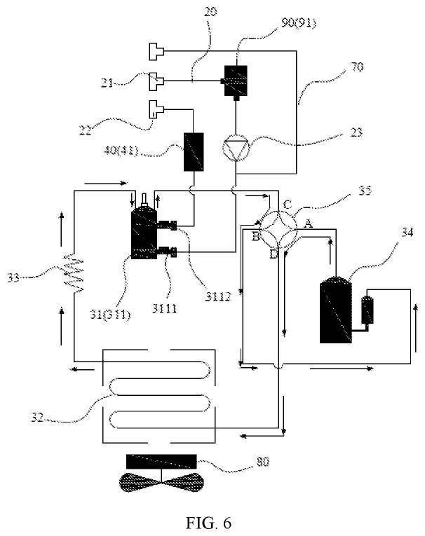

The dehumidifying and temperature adjustment device 30 in the embodiment of the present application is used as a device that can dehumidify the air and adjust the temperature of the water flow in the water circuit system 20. In some embodiments, please refer to FIG. 4 and FIG. 5 in conjunction with FIG. 3. FIG. 5 is a first schematic diagram of the swimming pool temperature adjustment equipment of the present application. The dehumidifying and temperature adjustment device 30 includes a first heat exchanger 31, a second heat exchanger 32, a throttling component 33, a refrigerant, and a compressor 34. The compressor 34, the first heat exchanger 31, the throttling component 33, and the second heat exchanger 32 are connected to each other in sequence. The second heat exchanger 32 is further connected to the compressor 34, so that the compressor 34, the first heat exchanger 31, the throttling component 33, and the second heat exchanger 32 form a refrigerant circulation loop, and the refrigerant can circulate and flow in the refrigerant circulation loop. The water flow in the water circuit system 20 flows through the first heat exchanger 31, and the first heat exchanger 31 is used to exchange heat with the water flow in the water circuit system 20. The second heat exchanger 32 is used to exchange heat with the air to dehumidify the air. The throttling component 33 may include an expansion valve playing a role of throttling. The compressor 34 can be a variable frequency compressor, so that efficiency of the compressor 34 can be adjusted according to requirements, so as to achieve a purpose of saving energy and electricity.

It can be understood that the refrigerant is compressed and transformed into high-temperature and high-pressure gas by the compressor 34. The gas enters the first heat exchanger 31 (the first heat exchanger 31 at this time can be understood as a condenser) and exchanges heat with the water flow in the water circuit system 20 at the first heat exchanger 31. At this time, the first heat exchanger 31 exchanges heat to the water flow in the water circuit system 20 to increase the temperature of the water. The refrigerant after cold absorption and heat release becomes liquid of medium temperature and high pressure, and after flowing through the throttling component 33, the refrigerant becomes liquid of low temperature and low pressure. The liquid enters the second heat exchanger 32 (the second heat exchanger 32 at this time can be understood as an evaporator) and exchanges heat with the air at the second heat exchanger 32 to lower the temperature and dehumidify the surrounding environment. It can be understood that moisture in the surrounding air condenses and releases heat when it encounters the second heat exchanger 32, and then reaches a dew point temperature, and becomes condensed water, which can flow to a bottom plate on the base portion 13 for collection and flowing away. The refrigerant flowing through the second heat exchanger 32 becomes a low-temperature and low-pressure gas after heat absorption and cold release, and returns to the compressor 34 again, and then the above-mentioned cycle process can be continued. Therefore, in the process of circulating the refrigerant in the refrigerant circulation loop, the first heat exchanger 31 can be used to heat up the temperature of the water flow in the water circuit system 20, and the second heat exchanger 32 can be used to exchange heat with the air to dehumidify the air.

For example, please continue to refer to FIG. 4 and FIG. 5, the first heat exchanger 31 may include a housing case 311 and a first refrigerant pipe. The first refrigerant pipe is arranged in the housing case 311. One end of the first refrigerant pipe is connected to the compressor 34, another end of the first refrigerant pipe is connected to the throttling component 33. The refrigerant can flow in the first refrigerant pipe. The water circuit system 20 is connected to the housing case 311, so that the water flow can exchange heat with the first refrigerant pipe in the housing case 311. For example, as shown in FIG. 5, the housing case 311 is provided with a water inlet end 3111 of the housing case 311 and a water outlet end 3112 of the housing case 311. The water circuit system 20 is connected to the water inlet end 3111 of the housing case 311 and the water outlet end 3112 of the housing case 311, so that the water flow in the water circuit system 20 can enter into the housing case 311 from the water inlet end 3111 of the housing case 311 and exchange heat with the refrigerant in the first refrigerant pipe. The water after exchanging heat can flow out from the water outlet end 3112 of the housing case 311 and then flow into the swimming pool out of the water outlet end 22 of the water circuit system 20. It can be understood that the first heat exchanger 31 can be a titanium tube heat exchanger.

In some embodiments, please refer to FIG. 4 and FIG. 5, the swimming pool temperature adjustment equipment 100 further includes a sewage pipe 70 connected to the housing case 311, so that when sewage accumulates in the housing case 311, the sewage in the housing case 311 can be discharged through the sewage pipe 70.

For example, the sewage pipe 70 is connected to one end of the housing case 311 close to a bottom wall of the housing case 311, so that the sewage can be better discharged.

In some embodiments, the second heat exchanger 32 includes a second refrigerant pipe. One end of the second refrigerant pipe is connected to the throttling component 33, and another end of the second refrigerant pipe is connected to the compressor 34. The refrigerant can flow through the second refrigerant pipe, so that the second heat exchanger 32 can exchange heat with the surrounding air.

Wherein, in order to improve efficiency of heat exchange, the second heat exchanger 32 may also include a thermal transfer sheet arranged on the second refrigerant pipe. The thermal transfer sheet can be in contact with a larger area of the air, so as to make a better effect of heat conduction. Under a heat-conducting effect of the thermal transfer sheet, the second refrigerant pipe and the thermal transfer sheet can exchange heat with the air together to dehumidify the air. Wherein the second heat exchanger 32 can be a fin heat exchanger.

In some embodiments, please continue to refer to FIG. 3 and FIG. 5, the dehumidifying and temperature adjustment device 30 may further include a four-way valve 35. The four-way valve 35 includes a first port A, a second port B, a third port C, and a fourth port D. A first end of the compressor 34 is connected to the first port A, and a second end of the compressor 34 is connected to the second port B; a first end of the first heat exchanger 31 is connected to the third port C, and a second end of the first heat exchanger 31 is connected to a first end of the throttling component 33, a second end of the throttling component 33 is connected to a first end of the second heat exchanger 32, and a second end of the second heat exchanger 32 is connected to the fourth port D. By setting the four-way valve 35, a flow direction of the refrigerant in the refrigerant circulation loop can be changed according to actual situations, so that the first heat exchanger 31 can cool or heat the water flow in the water circuit system, and then low-temperature swimming pool water or high-temperature swimming pool water can be obtained as required. It can be understood that low temperature and high temperature are relative terms, when weather temperature is high, water suitable for human body temperature can be called low-temperature water, and when the weather temperature is low, water suitable for the human body temperature can be called high-temperature water.

For example, in a heating mode, as shown in FIG. 5, directions of arrows in FIG. 5 indicate a circulating flow direction of the refrigerant. The four-way valve 35 may be in a stage that the first port A and the third port C are connected to each other, and the fourth port D and the second port B are connected to each other. At this time, the refrigerant can flow from the first end of the compressor 34 to the first port A, the third port C, the first heat exchanger 31, the throttling component 33, the second heat exchanger 32, the fourth port D, the second port B, and the second end of the compressor 34 in sequence. At this time, the refrigerant is compressed and transformed into the high-temperature and high-pressure gas by the compressor 34. The gas enters through the first port A of the four-way valve 35 and flows from the third port C of the four-way valve 35 to the first heat exchanger 31 (the first heat exchanger 31 at this time can be understood as a condenser). Specifically, the refrigerant flows from the third port C of the four-way valve 35 to the first refrigerant pipe of the first heat exchanger 31, and exchange heat with the water flow in the water circuit system 20 in the first heat exchanger 31. At this time, the first heat exchanger 31 exchanges heat to the water flow in the water circuit system 20 to increase temperature of the water. The refrigerant after heat absorption and cold release turns into a medium-temperature and high-pressure liquid. The refrigerant flows through the throttling component 33 and turns into low-temperature and low-pressure liquid, and the liquid enters into the second heat exchanger 32 (specifically, it can be in the second refrigerant pipe of the second heat exchanger 32, and the second heat exchanger 32 at this time can be understood as an evaporator). The liquid exchanges heat with the air in the second heat exchanger 32 for cooling and dehumidifying the surrounding environment. It can be understood that moisture in the surrounding air condenses and releases heat when it encounters the second heat exchanger 32, and then reaches the dew point temperature, and becomes condensed water. The condensed water can flow to the bottom plate on the base portion 13 for collection and flowing away. Wherein the refrigerant flowing through the second heat exchanger 32 becomes the low-temperature and low-pressure gas after heat absorption and cold release, and the gas flows into the fourth port D of the four-way valve 35 and flows from the second port B of the four-way valve 35 into the second end of the compressor 34, so that the refrigerant returns to the compressor 34 again, and then the above-mentioned cycle can be continued. Therefore, in the heating mode, when the refrigerant circulates in the refrigerant circulation loop, the first heat exchanger 31 can be used to heat up the water flow in the water circuit system 20, and the second heat exchanger 32 can be used to exchange heat with the air to dehumidify the air.

Alternatively, in a cooling mode, as shown in FIG. 6, FIG. 6 is a second schematic diagram of the swimming pool temperature adjustment equipment of the present application. Directions of arrows in FIG. 6 indicate a circulating flow direction of the refrigerant. The four-way valve 35 can be in a stage that the first port A and the fourth port D are connected to each other, and the third port C and the second port B are connected to each other. At this time, the refrigerant can flow from the first end of the compressor 34 to the first port A, the fourth port D, the second heat exchanger 32, the throttling component 33, the first heat exchanger 31, the third port C, the second port B, and the second end of the compressor 34. At this time, the refrigerant is compressed and transformed into the high-temperature and high-pressure gas by the compressor 34, and the gas enters from the first port A of the four-way valve 35 and flows from the fourth port D of the four-way valve 35 to the second heat exchanger 32 (the second heat exchanger 32 at this time can be understood as a condenser). Specifically, the refrigerant flows from the fourth port D of the four-way valve 35 to the second refrigerant pipe of the second heat exchanger 32. The refrigerant exchanges heat with the air in the second heat exchanger 32. Specifically, after releasing heat into the air, the refrigerant after the heat release becomes the medium-temperature and high-pressure liquid. The refrigerant becomes low-temperature and lower-pressure liquid after flowing through the throttling component 33. The liquid enters into the first heat exchanger 31 (specifically, it can be in the first refrigerant pipe of the first heat exchanger 31, and the first heat exchanger 31 at this time can be understood as an evaporator). The refrigerant exchanges heat with the water flow in the water circuit system 20 in the first heat exchanger 31. At this time, the refrigerant in the first heat exchanger 31 absorbs heat of the water flow in the water circuit system 20 to cool the water flow to obtain low-temperature water flow. The refrigerant flowing through the first heat exchanger 31 becomes low-temperature and lower-pressure gas after heat absorption and cold release. The gas flows through the third port C of the four-way valve 35 and flows from the second port B to the second end of the compressor 34, so that the refrigerant returns to the compressor 34 again, and then the above-mentioned cycle can be continued. Therefore, in the cooling mode, when the refrigerant circulates in the refrigerant circulation loop, the first heat exchanger 31 can be used to lower the temperature of the water flow in the water circuit system 20.

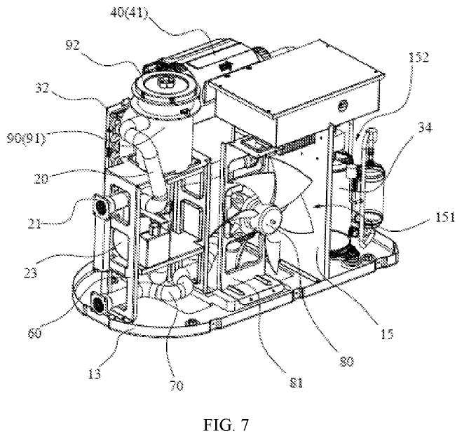

In some embodiments, the second heat exchanger 32 is used as a dehumidifying component. In order to better ensure circulation of air flow around the second heat exchanger 32, please refer to FIG. 7. FIG. 7 is a second schematic structural diagram of the swimming pool temperature adjustment equipment shown in FIG. 1 when the cover is not installed. The swimming pool temperature adjustment equipment 100 may further include a fan 80. The fan 80 is arranged in the container 10 and is located on one side of the second heat exchanger 32. The fan 80 can blow the air dehumidified by the second heat exchanger 32 to an outer side of the container 10.

For example, please continue to refer to FIG. 1 and FIG. 2 in conjunction with FIG. 7, an air inlet port 141 and an air outlet port 142 are provided on a wall of the container 10. The fan 80 can suck air from outside of the container 10 from the air inlet port 141 into the container 10 to make the air be dehumidified by the second heat exchanger 32. The dehumidified air can be continuously blown by the fan 80 to be discharged from the air outlet port 142, thereby realizing dehumidification of the surrounding air. The fan 80 accelerates flow of the air flow, which can also enhance an effect of dehumidification to a certain extent.

In order to improve air outlet efficiency, the air inlet port 141 is arranged opposite to the air outlet port 142. The second heat exchanger 32 and the fan 80 are arranged between the air inlet port 141 and the air outlet port 142. Wherein the second heat exchanger 32 is arranged on a side of the fan 80 facing the air inlet port 141, and the fan 80 is arranged on a side of the second heat exchanger 32 facing the air outlet port 142. It can also be understood that the second heat exchanger 32 is arranged close to the air inlet port 141. The fan 80 is arranged close to the air outlet port 142. This structure allows the air to enter and exit directly, and efficiency of air flowing in and out becomes higher.

Please continue to refer to FIG. 7, in order to better fix the fan 80, the fan 80 can be installed on the base portion 13 of the container 10 by a fan fixing frame 81.

For example, the fan 80 can be a variable frequency fan, so that efficiency of the fan 80 can be adjusted as required, so as to achieve a purpose of saving energy and electricity.

In order to effectively prevent dust from entering the container 10, filter plates may be provided at the air inlet port 141 and the air outlet port 142 of the container 10. For example, grid filters can be used.

Wherein in order to ensure that the dehumidification and heat exchange of the swimming pool water do not affect each other, the swimming pool temperature adjustment equipment 100 in the embodiment of the present application is provided with a space that allows the first heat exchanger 31 and the fan 80 to be relatively independent. For example, please continue to refer to FIG. 7, the swimming pool temperature adjustment equipment 100 may further include a separator 15. The separator 15 is arranged in the container 10 and separates the fan 80 from the first heat exchanger 31. A first space 151 capable of accommodating the fan 80 and a second space 152 capable of accommodating the first heat exchanger 31 are defined between the separator 15 and the container 10, so that environment temperature of the first space 151 after air in the first space exchanges heat with the second heat exchanger 32 will not affect the first heat exchanger 31 in the second space 152, which improves the relative independence of dehumidification and heat exchange of the swimming pool water. And this arrangement structure can also make an overall structure of the swimming pool temperature adjustment equipment 100 more compact, reducing occupied space and making installation and use more convenient.

The swimming pool water can be adjusted to temperature suitable for the human body by the swimming pool temperature adjustment equipment 100 in the embodiment of the present application. However, impurities, such as hair, may exist continuously during use of the swimming pool water. Based on this, please refer to FIG. 7, the swimming pool temperature adjustment equipment 100 in the embodiment of the present application is further provided with a filter device 90. The filter device 90 is connected to the water circuit system 20. And the filter device 90 is used to filter the impurities in the water circuit system 20. When the water flow in the water circuit system 20 flows through the filter device 90, it can be filtered by the filter device 90, thereby obtaining relatively pure water.

As shown in FIG. 5, a position of the filter device 90 can be set such that: the filter device 90 is closer to the water inlet end 21 of the water circuit system 20 than the first heat exchanger 31 in the water circuit system 20, that is, the swimming pool water first passes through the filter device 90 to be filtered, and then flows to the first heat exchanger 31 for heat exchanging. This arrangement can effectively prevent downstream components of the water circuit system 20, such as the first heat exchanger 31, from being blocked by impurities, thereby affecting service life of the first heat exchanger 31.

For example, as shown in FIG. 4, the filter device 90 includes a filter shell 91 and a filter element. The filter element is arranged in the filter shell 91, and the water circuit system 20 is connected to the filter shell 91, so that the water flow can be filtered by the filter element in the filter shell 91.

As shown in FIG. 4, the filter device 90 can be installed in the container 10 by the second mounting bracket 60. For example, the second mounting bracket 60 is fixedly installed on the base portion 13 of the container 10, and the filter shell 91 of the filter device 90 is fixedly installed on the second mounting bracket 60.

The filter element will be gradually polluted by the impurities during use. In order to improve practicability of the filter device 90, the filter shell 91 and the filter element are made into a detachable structure in the embodiment of the present application, that is, the filter element is detachably installed in the filter shell 91. When the filter element is polluted by the impurities, it is only necessary to remove the filter element from the filter shell 91 and replace it, and the entire filter device 90 does not need to be replaced, which is convenient and quick, and saves cost. For example, the filter element can be detachably connected to the filter shell 91 by means of bolt connection, snap connection, or screw connection.

In order to facilitate removal of the filter element, as shown in FIG. 2, a yield hole is provided on the wall of the container 10, so that a part of the filter element, such as a filter element cover 92, is located outside of the container 10 to facilitate removal of the filter element. It can be understood that the filter element includes a filter element body and the filter element cover 92. The filter element body is connected to the filter element cover 92 and is located in the filter shell 91.

In some embodiments, as shown in FIG. 4 and FIG. 5, the water circuit system 20 includes a water pump 23. The water pump 23 is connected to the first heat exchanger 31 by a pipeline, so as to realize flow of water. It can be understood that the water pump 23 provides power for the flow of water. For example, the water pump 23 can be a water pump 23 with a gear adjustment function, so that a suitable gear can be selected according to a size of the swimming pool, which is more practical. The water pump 23 may be connected to the sewage pipe 70, so that the sewage can be discharged from the sewage pipe 70 when the sewage is accumulated in the water pump 23.

When the filter device 90 is provided, the water pump 23 can be arranged between the filter device 90 and the first heat exchanger 31. It can be understood that the water pump 23 and the filter device 90 are connected through a pipeline, and the water pump 23 and the first heat exchanger 31 are connected through a pipeline.

As shown in FIG. 4, the water pump 23 can be installed on the second mounting bracket 60, that is, the filter device 90 and the water pump 23 can be installed on a same second mounting frame 60, which can make full use of space in the container 10, so that the swimming pool temperature adjustment equipment 100 is more compact. Furthermore, the filter device 90 can be arranged above the water pump 23, that is, the filter device 90 and the water pump 23 are arranged in an up-and-down direction in the space, which further utilizes the space in the container 10.

The swimming pool temperature adjustment equipment 100 provided in the embodiment of the present application disinfects the water through the disinfection device 40. For example, please continue to refer to FIG. 4 and FIG. 5, the disinfection device 40 includes a salt chlorine generator 41. The salt chlorine generator 41 is connected to the water circuit system 20, so that chlorine gas generated by the salt chlorine generator 41 disinfects the water flow of the water circuit system 20. It can be understood that the salt chlorine generator 41 includes a cylindrical body, and an anode sheet and a cathode sheet both arranged in the cylindrical body, the anode sheet and the cathode sheet are spaced apart, and the anode sheet and the cathode sheet are used to electrolyze water containing chlorine in the cylindrical body to generate the chlorine gas which is used to disinfect the water. It can be understood that when the water in the cylinder body contains a defined amount of residual chlorine, the water can undergo electrolysis when it flows through the anode sheet and the cathode sheet after electrification. The chlorine gas generated in a gap between the anode sheet and the cathode sheet is used to disinfect the water.

For example, the disinfection device 40 may be arranged close to the water outlet end 22 of the water circuit system 20, that is, the disinfection device 40 is connected to the water outlet end 3112 of the housing case 311 of the first heat exchanger 31. The water flow in the water circuit system 20 flows through the first heat exchanger 31 and then is disinfected by the disinfection device 40.

Wherein in order to detect chlorine concentration of the water flow in the water circuit system 20, the swimming pool temperature adjustment equipment 100 provided in the embodiment of the present application is provided with a residual chlorine sensor in the salt chlorine generator 41 and the residual chlorine sensor is used to detect the chlorine concentration in the water in water circuit system 20. It can be understood that the residual chlorine sensor is connected to a controller, and the controller can be configured with an alarm prompt function. When the residual chlorine sensor detects that the chlorine concentration in the water is lower than a preset value, the controller can automatically alarm and prompt.

In some embodiments, a salting tank is provided on the salt chlorine generator 41. A connecting channel is provided between the salting tank and the cylindrical body of the salt chlorine generator 41 which is used for connecting the salting tank and the cylindrical body of the salt chlorine generator 41. The connecting channel is provided with a valve, and the valve is used to open or close the connecting channel. The salting tank contains chlorine-containing salt or chlorine-containing solution. It can be understood that the chlorine-containing salt mixed with water to form the solution or chlorine-containing solution needs to be electrolyzed and produce chlorine gas, such as sodium chloride or sodium chloride solution. When the residual chlorine sensor detects that the chlorine concentration in the water is lower than the preset value, the valve can be opened to make the chlorine-containing salt or chlorine-containing solution flow into the cylindrical body of the salt chlorine generator 41 until the controller no longer alarms, and then the valve can be closed. It can be understood that the valve can be configured to be opened manually or automatically, which is not limited in this embodiment of the present application.

It can be understood that the swimming pool temperature adjustment equipment 100 provided in the embodiment of the present application needs to be driven by electricity. In order to improve usage safety of the swimming pool temperature adjustment equipment 100, the swimming pool temperature adjustment equipment 100 is provided with a power plug with leakage protection to prevent leakage of the swimming pool temperature adjustment equipment 100 from causing harm. It can be understood that the power plug can be connected to an external power source so as to supply power to the components in the swimming pool temperature adjustment equipment 100 requiring electricity.

In the above-mentioned embodiments, the description of each embodiment has its own emphasis. For parts that are not described in detail in a certain embodiment, reference may be made to the relevant descriptions of other embodiments.

In the description of the present application, terms “first” and “second” are only used for description purposes and cannot be understood as indicating or implying relative importance or implying a number of indicated technical features. Therefore, features defined as “first”, “second” may expressly or implicitly include one or more features.

The swimming pool temperature adjustment equipment provided by the embodiments of the present application is described in detail above. In above-mentioned text, principles and embodiment mode of the present application are expounded with specific examples, and above-mentioned specific examples are only for helping to understand this disclosure. Moreover, for those skilled in the art, there will be changes in the specific embodiment and disclosure scope according to ideas of this disclosure. In summary, the content of this specification should not be understood as a limitation to this disclosure.

What is claimed is:

1. A swimming pool temperature adjustment equipment, comprising:
a container having a water inlet port and a water outlet port;
a water circuit system arranged in the container and having a water inlet end and a water outlet end, the water inlet end connected to the water inlet port, and the water outlet end connected to the water outlet port;
a dehumidifying and temperature adjustment device arranged in the container, and water flow in the water circuit system flowing through the dehumidifying and temperature adjustment device, the dehumidifying and temperature adjustment device used to adjust temperature of the water flow in the water circuit system, and the dehumidifying and temperature adjustment device also used to dehumidify air; and
a disinfection device connected to the water circuit system, and the disinfection device used to disinfect the water flow in the water circuit system.

2. The swimming pool temperature adjustment equipment as claimed in claim 1, wherein the dehumidifying and temperature adjustment device comprises a first heat exchanger, a second heat exchanger, a throttling component, a refrigerant, and a compressor; the compressor, the first heat exchanger, the throttling component, and the second heat exchanger are connected to each other in sequence; and the second heat exchanger is further connected to the compressor, so that the compressor, the first heat exchanger, the throttling component, and the second heat exchanger form a refrigerant circulation loop, and the refrigerant is circulatable and flowable in the refrigerant circulation loop;
the water flow in the water circuit system flows through the first heat exchanger, and the first heat exchanger is used to exchange heat with the water flow in the water circuit system; and
the second heat exchanger is used to exchange heat with the air to dehumidify the air.

3. The swimming pool temperature adjustment equipment as claimed in claim 2, wherein the first heat exchanger comprises a housing case, and a first refrigerant pipe arranged in the housing case; one end of the first refrigerant pipe is connected to the compressor, and another end of the first refrigerant pipe is connected to the throttling component; and the water circuit system is connected to the housing case, so that the water flow is able to exchange heat with the first refrigerant pipe in the housing case.

4. The swimming pool temperature adjustment equipment as claimed in claim 2, wherein the second heat exchanger comprises a second refrigerant pipe; one end of the second refrigerant pipe is connected to the throttling component, and another end of the second refrigerant pipe is connected to the compressor.

5. The swimming pool temperature adjustment equipment as claimed in claim 4, wherein the second heat exchanger further comprises a thermal transfer sheet arranged on the second refrigerant pipe, and the second refrigerant pipe and the thermal transfer sheet are used to exchange heat with the air to dehumidify the air.

6. The swimming pool temperature adjustment equipment as claimed in any one of claims 2-5, wherein the dehumidifying and temperature adjustment device further comprises a four-way valve comprising a first port, a second port, a third port, and a fourth port; a first end of the compressor is connected to the first port, a second end of the compressor is connected to the second port; a first end of the first heat exchanger is connected to the third port, a second end of the first heat exchanger is connected to a first end of the throttling component, a second end of the throttling component is connected to a first end of the second heat exchanger, and a second end of the second heat exchanger is connected to the fourth port.

7. The swimming pool temperature adjustment equipment as claimed in claim 6, wherein the refrigerant is able to flow from the first end of the compressor to the first port, the third port, the first heat exchanger, the throttling component, the second heat exchanger, the fourth port, the second port, and the second end of the compressor in sequence.

8. The swimming pool temperature adjustment equipment as claimed in claim 6, wherein the refrigerant is able to flow from the first end of the compressor to the first port, the fourth port, the second heat exchanger, the throttling component, the first heat exchanger, the third port, the second port, and the second end of the compressor in sequence.

9. The swimming pool temperature adjustment equipment as claimed in claim 2, wherein the swimming pool temperature adjustment equipment further comprises a fan, the fan is arranged in the container and is located on one side of the second heat exchanger, and the fan is able to blow the air dehumidified by the second heat exchanger to an outer side of the container.

10. The swimming pool temperature adjustment equipment as claimed in claim 9, wherein the container is provided with an air inlet port and an air outlet port, the air inlet port is arranged opposite to the air outlet port, and the second heat exchanger and the fan are arranged between the air inlet port and the air outlet port.

11. The swimming pool temperature adjustment equipment as claimed in claim 10, wherein the second heat exchanger is arranged on one side of the fan facing the air inlet port, and the fan is arranged on one side of the second heat exchanger facing the air outlet port.

12. The swimming pool temperature adjustment equipment as claimed in claim 9, wherein the swimming pool temperature adjustment equipment further comprises a separator arranged in the container; the separator separates the fan from the first heat exchanger, and a first space accommodating the fan and a second space accommodating the first heat exchanger are defined between the separator and the container.

13. The swimming pool temperature adjustment equipment as claimed in claim 1, wherein the disinfection device comprises a salt chlorine generator connected to the water circuit system, and the salt chlorine generator is used to disinfect the water flow in the water circuit system.

14. The swimming pool temperature adjustment equipment as claimed in claim 13, wherein a residual chlorine sensor is arranged in the salt chlorine generator, and the residual chlorine sensor is used to detect chlorine concentration of the water flow in the water circuit system.

15. The swimming pool temperature adjustment equipment as claimed in claim 1, wherein the container comprises a base portion, and a cover arranged on the base portion; the swimming pool temperature adjustment equipment further comprises a first mounting bracket arranged in the cover, the first mounting bracket is arranged on a wall of the cover, and the disinfection device is arranged on the first mounting bracket.

16. The swimming pool temperature adjustment equipment as claimed in claim 1, wherein the swimming pool temperature adjustment equipment further comprises a filter device connected to the water circuit system, and the filter device is used to filter impurities in the water circuit system.

17. The swimming pool temperature adjustment equipment as claimed in claim 16, wherein the filter device comprises a filter shell and a filter element, the filter element is detachably arranged in the filter shell, and the water circuit system is connected to the filter shell.

18. The swimming pool temperature adjustment equipment as claimed in claim 16, wherein the water circuit system comprises a water pump, and the water pump is connected to the filter device through a pipeline.

19. The swimming pool temperature adjustment equipment as claimed in claim 18, wherein the swimming pool temperature adjustment equipment further comprises a second mounting bracket arranged in the container, and the filter device and the water pump are both arranged on the second mounting bracket.

20. The swimming pool temperature adjustment equipment as claimed in claim 1, wherein the container is provided with a handle.
